(19) United States
(12) Patent Application Publication
(10) Pub. No.: US 2022/0373053 A1
(43) Pub. Date: Nov. 24, 2022

(54) FRICTION MATERIAL

(71) Applicant: AKEBONO BRAKE INDUSTRY CO., LTD., Chuo-ku, Tokyo (JP)

(72) Inventors: Atsushi KODA, Chuo-ku, Tokyo (JP); Kazuhiko OISHI, Chuo-ku, Tokyo (JP); Hiroyuki KIMURA, Chuo-ku, Tokyo (JP)

(73) Assignee: AKEBONO BRAKE INDUSTRY CO., LTD., Chuo-ku, Tokyo (JP)

(21) Appl. No.: 17/786,668

(22) PCT Filed: Dec. 14, 2020
(86) PCT No.: PCT/JP2020/046600

§ 371 Date: Jun. 17, 2022

(30) Foreign Application Priority Data
Dec. 19, 2019 (JP) 2019-229438

(51) Int. Cl. F16D 69/02

(52) U.S. Cl. CPC F16D 69/026; F16D 2200/0073; F16D 2200/0065

(57) ABSTRACT

A friction material including a friction modifier, a binder, and a fiber base material. A steel fiber is contained as the fiber base material. A natural graphite is contained as a lubricant. A content of copper is 0.5% by mass or less in terms of copper element. A titanate is not contained.

### TECHNICAL FIELD

The present invention relates to a friction material to be used in automobiles, railroad vehicles, industrial machines, and the like.

### BACKGROUND ART

During braking with a brake, vibration generated by a contact between a friction material and a counterpart material may be amplified by a counterpart material body, and an unpleasant noise may be generated. This unpleasant noise is called a brake noise, and automobile users want to prevent the brake noise as much as possible.

As a friction material that can prevent the brake noise, for example, Patent Literature 1 discloses a non-asbestos friction material obtained by molding and curing a non-asbestos friction material composition mainly composed of a fiber base material containing at least a steel fiber excluding asbestos, a binder, and a filler, in which the non-asbestos friction material contains petroleum coke having an average particle diameter of 50 μm to 150 μm and hard inorganic particles having an average particle diameter of 5 μm to 30 μm.

In addition, since the friction material is required to have sufficient strength, the friction material may contain a titanate in order to improve the strength.

As a friction material having improved strength due to a titanate, for example, Patent Literature 2 discloses a friction material not containing a simple substance and alloy of a metal, in which the friction material contains 20% by volume to 30% by volume of a plate-like titanate having an average particle diameter of 10 μm to 50 μm and hydrous magnesium silicate in total with respect to a total amount of the friction material, and a volume ratio of the titanate to the hydrous magnesium silicate is 12:1 to 5:1.

### CITATION LIST

### Patent Literature

Patent Literature 1: JP-A-2004-155843
Patent Literature 2: JP-A-2012-197352

### SUMMARY OF INVENTION

### Technical Problem

However, according to the study of the present inventors, the friction material described in Patent Literature 1 can prevent the brake noise, but the friction coefficient is not sufficient.

In addition, in the friction material described in Patent Literature 2, a transfer film may be formed on the surface of the counterpart material due to the titanate, and the friction coefficient may decrease.

The present invention has been made in view of the above circumstances, and an object thereof is to provide a high-strength friction material having a sufficient friction coefficient and capable of preventing a brake noise.

### Solution to Problem

As a result of intensive studies, the present inventors have found that when a friction material contains a steel fiber as a fiber base material, and contains natural graphite as a lubricant, the strength of the friction material can be improved without containing a titanate, a sufficient friction coefficient can be provided, and the brake noise can be prevented. Thus, the present invention has been completed.

That is, the present invention relates to the following <1> to <5>.

<1> A friction material containing:

a friction modifier;

a binder; and

a fiber base material, in which

a steel fiber is contained as the fiber base material,

natural graphite is contained as a lubricant,

a content of copper is 0.5% by mass or less in terms of copper element, and

a titanate is not contained.

<2> The friction material according to <1>, in which a content of the natural graphite is 1.0% by mass to 5.0% by mass.

<3> The friction material according to <1> or <2>, in which a content of the steel fiber is 10% by mass to 50% by mass.

<4> The friction material according to any one of <1> to <3>, in which coke is further contained as the lubricant.

<5> The friction material according to any one of <1> to <4>, in which magnesium oxide is contained as an abrasive.

### Advantageous Effects of Invention

According to the present invention, it is possible to provide a high-strength friction material having a sufficient friction coefficient and capable of preventing a brake noise.

In addition, the friction material of the present invention can prevent the aggressiveness against the counterpart material.

### DESCRIPTION OF EMBODIMENTS

Hereinafter, the present invention will be described in detail, but these show examples of desirable embodiments, and the present invention is not specified in these contents.

A friction material of the present invention contains: a friction modifier; a binder; and a fiber base material.

Hereinafter, each component will be described in detail.

### <Friction Modifier>

Examples of the friction modifier include a lubricant, an abrasive, and other friction modifiers (inorganic filler and organic filler).

### (Lubricant)

The friction material of the present invention contains natural graphite as the lubricant.

The natural graphite is graphite that is naturally produced as an ore. Since the natural graphite has high lubricity, when the friction material of the present invention contains the natural graphite, it is possible to prevent the aggressiveness against the counterpart material and the brake noise of the friction material.

The natural graphite is classified into vein graphite, flake graphite, and amorphous graphite according to the appearance thereof. Among these, vein graphite having the highest lubricity is preferably used.

Vein graphite is natural graphite that exists mostly in the form of veins and has a scaly-like (lumpy) appearance. Since particles of vein graphite are scaly (lumpy), the aspect ratio is small, and the crystallinity is higher and the thickness is larger than that of flake graphite and amorphous graphite. Therefore, vein graphite has very high lubricity.

The content of the natural graphite in the entire friction material is preferably 1.0% by mass to 5.0% by mass, more preferably 1.2% by mass to 4.5% by mass, and still more preferably 1.5% by mass to 4.0% by mass. When the content of the natural graphite is 1.0% by mass or more, since the friction material of the present invention can be provided with sufficient lubricity, it is possible to prevent the aggressiveness against the counterpart material and the brake noise of the friction material. When the content of the natural graphite is 5.0% by mass or less, it is possible to prevent a decrease in the friction coefficient caused by excessive lubrication of the friction material.

The average particle diameter of the natural graphite is preferably 1 μm to 200 μm, more preferably 3 μm to 100 μm, and still more preferably 5 μm to 100 μm. When the average particle diameter of the natural graphite is 1 μm or more, the lubricity of the friction material can be improved and the aggressiveness against the counterpart material can be prevented. When the average particle diameter of the natural graphite is 200 μm or less, it is possible to prevent a decrease in the friction coefficient during high-speed braking.

In the present invention, the average particle diameter means a value (median diameter) measured by a laser diffraction type particle size distribution measuring device. The average particle diameter can also be measured by a sieving method.

The friction material of the present invention preferably contains coke as the lubricant. When the coke is contained in the friction material of the present invention, the aggressiveness against the counterpart material of the friction material can be prevented by a lubricity-imparting action.

There are two types of coke, coal coke and petroleum coke, both of which can be used.

The content of the coke in the entire friction material is preferably 3.0% by mass to 10.0% by mass, more preferably 4.0% by mass to 9.0% by mass, and still more preferably 5.0% by mass to 8.0% by mass, from the viewpoint of preventing the aggressiveness against the counterpart material.

The average particle diameter of the coke is preferably 200 μm to 1000 μm, more preferably 300 μm to 900 μm, and still more preferably 400 μm to 800 μm. When the average particle diameter of the coke is 200 μm or more, the lubricity of the friction material is sufficient, and wear resistance can be improved. When the average particle diameter of the coke is 1000 μm or less, the coke is difficult to fall off from the friction material, and deterioration of wear can be prevented.

Examples of the lubricant include artificial graphite, antimony trisulfide, molybdenum disulfide, tin sulfide, and polytetrafluoroethylene (PTFE), in addition to the above. These lubricants can be used alone or in combination of two or more thereof.

The content of the lubricant in the entire friction material is preferably 1% by mass to 40% by mass, more preferably 3% by mass to 35% by mass, and still more preferably 5% by mass to 30% by mass, from the viewpoint of preventing the aggressiveness against the counterpart material and the brake noise.

### (Abrasive)

Examples of the abrasive include magnesium oxide, alumina, silica, zirconia, zirconium silicate, chromium oxide, triiron tetroxide (Fe₃O₄), and chromite. These abrasives can be used alone or in combination of two or more thereof.

The content of the abrasive in the entire friction material is preferably 3% by mass to 35% by mass, more preferably 5% by mass to 30% by mass, and still more preferably 10% by mass to 25% by mass, from the viewpoint of imparting appropriate abradability.

The friction material of the present invention preferably contains magnesium oxide as the abrasive. The Mohs hardness of magnesium oxide is about 6, which is slightly higher than the Mohs hardness of 4 of a cast iron as the counterpart material. When magnesium oxide is contained in the friction material of the present invention, the sliding surface of the counterpart material can be appropriately ground as compared with the case where only other abrasive materials are used, and the friction coefficient can be improved.

The content of magnesium oxide in the entire friction material is preferably 3.0% by mass to 10.0% by mass, more preferably 4.0% by mass to 9.0% by mass, and still more preferably 5.0% by mass to 8.0% by mass, from the viewpoint of preventing an increase in friction coefficient.

The average particle diameter of magnesium oxide is preferably 1 μm to 100 μm, more preferably 10 μm to 90 μm, and still more preferably 25 μm to 80 μm, from the viewpoint of improving the friction coefficient.

### (Other Friction Modifiers)

Other friction modifiers (inorganic filler and organic filler) are used to impart desired friction characteristics such as wear resistance, heat resistance, and fade resistance to the friction material.

Examples of the inorganic filler include inorganic materials such as barium sulfate, calcium carbonate, calcium hydroxide, vermiculite, and mica, and metal powders of aluminum, tin and zinc. These inorganic fillers can be used alone or in combination of two or more thereof.

Examples of the organic filler include various rubber powders (raw rubber powder, tire powder, etc.), cashew dust, tire tread, and melamine dust. These organic fillers can be used alone or in combination of two or more thereof.

The friction modifier is preferably used in an amount of 20% by mass to 80% by mass, and more preferably 30% by mass to 70% by mass in the entire friction material, from the viewpoint of sufficiently imparting the desired friction characteristics to the friction material.

### <Binder>

As the binder, various commonly used binders can be used. Specific examples thereof include thermosetting resins such as a phenol resin, a modified phenol resin, a melamine resin, an epoxy resins, and a polyimide resin.

Examples of the modified phenol resin include an elastomer-modified phenol resin. Examples of the elastomer-modified phenol resin include an acrylic rubber-modified phenolic resin, a silicone rubber-modified phenolic resin, and a nitrile rubber (NBR)-modified phenolic resin. These modified phenol resins can be used alone or in combination of two or more thereof.

From the viewpoint of moldability of the friction material, the binder is preferably used in an amount of 1% by mass to 20% by mass, and more preferably 3% by mass to 15% by mass in the entire friction material.

### <Fiber Base Material>

The friction material of the present invention contains a steel fiber as the fiber base material. When the steel fiber is contained in the friction material of the present invention, the friction material of the present invention can be used as a friction material having high strength, and the friction coefficient during fading can be improved.

The content of the steel fiber in the entire friction material is preferably 10% by mass to 50% by mass, more preferably 20% by mass to 45% by mass, and still more preferably 25% by mass to 40% by mass.

When the content of the steel fiber is 10% by mass or more, sufficient strength of the friction material can be ensured. When the content of the steel fiber is 50% by mass or less, the friction material can be prevented from becoming too heavy.

The average fiber length of the steel fiber is preferably 0.5 mm to 30 mm, more preferably 0.5 mm to 20 mm, and still more preferably 0.5 mm to 10 mm. When the average fiber length of the steel fiber is 0.5 mm or more, the strength of the friction material can be ensured. When the average fiber length of the steel fiber is 30 mm or less, deterioration due to the aggressiveness against the counterpart material can be prevented.

The average fiber diameter of the steel fiber is preferably 10 μm to 600 μm, more preferably 30 μm to 500 μm, and still more preferably 50 μm to 400 μm. When the average fiber diameter of the steel fiber is 10 μm or more, the strength of the friction material can be ensured. When the average fiber diameter of the steel fiber is 600 μm or less, deterioration due to the aggressiveness against the counterpart material can be prevented.

In the present invention, the average fiber length and the average fiber diameter of the steel fiber can be measured by observing with a microscope or the like.

Examples of the fiber base material include an organic fiber and an inorganic fiber in addition to the above. These fiber base materials can be used alone or in combination of two or more thereof.

Examples of the organic fiber include an aromatic polyamide (aramid) fiber and a flame-resistant acrylic fiber.

Examples of the inorganic fiber include a biosoluble inorganic fiber, a ceramic fiber, a glass fiber, a carbon fiber, and rock wool. Examples of the biosoluble inorganic fiber include biosoluble ceramic fibers such as a SiO₂—CaO—MgO-based fiber, a SiO₂—CaO—MgO—Al₂O₃-based fiber, a SiO₂—MgO—SrO-based fiber, and biosoluble rock wool.

From the viewpoint of ensuring strength of the friction material, the fiber base material is preferably used in an amount of 10% by mass to 60% by mass, and more preferably 20% by mass to 60% by mass in the entire friction material.

The content of a copper component in the entire friction material of the present invention is 0.5% by mass or less in terms of a copper element, and it is preferable that the friction material of the present invention preferably does not contain the copper component, from the viewpoint of reducing the environmental load.

Further, the friction material of the present invention does not contain a titanate. When the titanate is not contained, the friction coefficient can be prevented from decreasing caused by the formation of a transfer film on the surface of the counterpart material due to the titanate.

### <Method for Producing Friction Material>

The friction material of the present invention can be produced by a known production process. For example, the friction material of the present invention can be produced by blending the above components, and subjecting the blended material to steps such as preforming, hot molding, and grinding according to a usual production method.

A method for producing a brake pad provided with the friction material generally includes the following steps:

(a) a step of forming a pressure plate into a predetermined shape by using a sheet metal press;

(b) a step of applying a degreasing treatment, a chemical conversion treatment, and a primer treatment to the pressure plate and coating the pressure plate with an adhesive;

(c) a step of blending raw materials such as a friction modifier, a binder, and a fiber base material, sufficiently homogenizing by mixing, and performing molding at a predetermined pressure at normal temperature to prepare a preformed body;

(d) a hot molding step of integrally fixing the preformed body and the pressure plate coated with the adhesive by applying a predetermined temperature and pressure (molding temperature: 130° C. to 180° C., molding pressure: 30 MPa to 80 MPa, molding time: 2 minutes to 10 minutes); and

(e) a step of performing after-cure (150° C. to 300° C., 1 hour to 5 hours) and finally performing finishing treatments such as grinding, scorching, and painting.

### EXAMPLES

The present invention will be specifically described by way of the following Examples, but the present invention is not limited thereto.

### Examples 1 to 14 and Comparative Examples 1 and 2

Compounding materials shown in Table 1 are collectively charged into a mixing stirrer and mixed at normal temperature for 5 minutes to obtain a mixture. As the natural graphite, “CD-150” (manufactured by Nippon Graphite Industry Co., Ltd.) is used.

The obtained mixture is subjected to the following steps of (i) preforming, (ii) hot molding, and (iii) heat treatment and scorching to produce a friction material.

### (i) Preforming

The mixture is charged into a mold of a preforming press and molded at normal temperature at 20 MPa for 10 seconds to prepare a preformed body.

### (ii) Hot Molding

The preformed body is charged into a hot molding mold, metal plates (pressure plates) coated with an adhesive in advance are stacked, and hot-press molding is performed at 150° C. and 50 MPa for 6 minutes.

(iii) Heat Treatment and Scorching

The hot-pressed molded body is subjected to a heat treatment at 250° C. for 3 hours and then the surface thereof is ground.

Next, the surface of the hot-pressed molded body is scorched and finished with a painting to obtain the friction material.

The strength, the friction performance, the aggressiveness against the counterpart material, and the brake noise of the friction material obtained in each of Examples 1 to 14 and Comparative Examples 1 and 2 are evaluated according to the following methods. The results are shown in Table 1.

### <Strength>

With respect to the friction material obtained above, the normal temperature shear strength of the friction material is measured according to JIS D4422 (bonding area: 50 cm²). For the measured value, the stress at the time of shear failure is divided by the area of the friction material to calculate the shear force per unit area (N/cm²).

The measured shear strength is evaluated based on the following criteria.

A: 600 N/cm² or more

B: 500 N/cm² or more and less than 600 N/cm²

C: 400 N/cm² or more and less than 500 N/cm²

### <Friction Performance>

The friction material obtained above was subjected to a friction performance test according to JASO C406 using a dynamometer, and the friction coefficient in the second effectiveness (initial speed: 130 km/h, deceleration: 0.6 G) and the lowest friction coefficient in the first fade are measured.

The friction coefficient measured in the second effectiveness is evaluated based on the following criteria.

A: 0.40 or more

B: 0.35 or more and less than 0.40

C: 0.30 or more and less than 0.35

D: less than 0.30

The lowest friction coefficient measured in the first fade was evaluated based on the following criteria.

A: 0.30 or more

B: 0.25 or more and less than 0.30

C: 0.20 or more and less than 0.25

D: less than 0.20

### <Aggressiveness Against the Counterpart Material>

The wear amount of the counterpart material after the above friction performance test is measured and evaluated based on the following criteria.

A: 15 μm or less

B: more than 15 μm and 20 μm or less

C: more than 20 μm and 25 μm or less

D: more than 25 μm

### <Brake Noise>

The friction material obtained above is mounted on an actual vehicle, a brake noise test is performed according to JASO C402, and the sound pressure (dB) of the brake noise is measured. The occurrence rate (%) of the brake noise of 70 dB or more is calculated according to the following formula.

Occurrence rate (%) of brake noise of 70 dB or more={Number of occurrence of brake noise of 70 dB or more/Number of brakes}×100

The calculated occurrence rate (%) of the brake noise of 70 dB or more is evaluated based on the following criteria.

A: 0%

B: more than 0% and less than 5%

C: 5% or more and less than 10%

D: more than 10%

TABLE 1

| | | | | Example | | | | | | | | |
|---|---|---|---|---|---|---|---|---|---|---|---|---|
| (% by mass) | | | | 1 | 2 | 3 | 4 | 5 | 6 | 7 | 8 | 9 |
| Blending | Binder | | Phenol | 7.0 | 7.0 | 7.0 | 7.0 | 7.0 | 7.0 | 7.0 | 7.0 | 7.0 |
| compo- | | | resin | | | | | | | | | |
| sition | Friction | Inorganic | Calcium | 5.0 | 5.0 | 5.0 | 5.0 | 5.0 | 5.0 | 5.0 | 5.0 | 5.0 |
| | modifier | filler | hydroxide | | | | | | | | | |
| | | | Barium | 21.0 | 20.0 | 19.0 | 21.0 | 18.0 | 17.0 | 16.0 | 14.0 | 11.0 |
| | | | sulfate | | | | | | | | | |
| | | | Potassium | — | — | — | — | — | — | — | — | — |
| | | | titanate | | | | | | | | | |
| | | | Zinc powder | 6.0 | 6.0 | 6.0 | 6.0 | 6.0 | 6.0 | 6.0 | 6.0 | 6.0 |
| | | Abrasive | Alumina | 3.0 | 3.0 | 3.0 | 3.0 | 3.0 | 3.0 | 3.0 | 3.0 | 3.0 |
| | | | Zirconium | 5.0 | 5.0 | 5.0 | 5.0 | 5.0 | 5.0 | 5.0 | 5.0 | 5.0 |
| | | | silicate | | | | | | | | | |
| | | | Magnesium | — | — | — | — | — | — | — | — | — |
| | | | oxide | | | | | | | | | |
| | | | Chromium | 5.0 | 5.0 | 5.0 | 5.0 | 5.0 | 5.0 | 5.0 | 5.0 | 5.0 |
| | | | oxide | | | | | | | | | |
| | | Lubricant | Tin sulfide | 10.0 | 10.0 | 10.0 | 10.0 | 10.0 | 10.0 | 10.0 | 10.0 | 10.0 |
| | | | Coke | — | — | — | — | — | — | 3.0 | 5.0 | 8.0 |
| | | | Natural | 1.0 | 2.0 | 3.0 | 3.0 | 4.0 | 5.0 | 3.0 | 3.0 | 3.0 |
| | | | graphite | | | | | | | | | |
| | | | Artificial | 2.0 | 2.0 | 2.0 | — | 2.0 | 2.0 | 2.0 | 2.0 | 2.0 |
| | | | graphite | | | | | | | | | |

| | | | | | | | | | | |
|---|---|---|---|---|---|---|---|---|---|---|
| Fiber base | Aramid fiber | 5.0 | 5.0 | 5.0 | 5.0 | 5.0 | 5.0 | 5.0 | 5.0 | 5.0 |
| material | Steel fiber | 30.0 | 30.0 | 30.0 | 30.0 | 30.0 | 30.0 | 30.0 | 30.0 | 30.0 |

| Total amount (% by mass) | | | 100.0 | 100.0 | 100.0 | 100.0 | 100.0 | 100.0 | 100.0 | 100.0 | 100.0 |
|---|---|---|---|---|---|---|---|---|---|---|---|
| Evalu- | Strength | Shear strength (N/cm²) | 630 | 640 | 625 | 605 | 610 | 590 | 600 | 580 | 570 |
| ation | | at normal temperature | | | | | | | | | |
| | Friction | Friction coefficient | 0.41 | 0.39 | 0.38 | 0.40 | 0.37 | 0.34 | 0.37 | 0.37 | 0.37 |
| | performance | in second effectiveness | | | | | | | | | |
| | | Lowest friction coefficient | 0.30 | 0.28 | 0.26 | 0.28 | 0.26 | 0.25 | 0.26 | 0.26 | 0.25 |
| | | in first fade | | | | | | | | | |
| | Aggressiveness | Wear amount (μm) | 19.5 | 17.3 | 14.6 | 16.8 | 13.4 | 11.2 | 13.9 | 13.1 | 12.7 |
| | against | of counterpart | | | | | | | | | |
| | counterpart | material | | | | | | | | | |
| | material | | | | | | | | | | |
| | Brake noise | Occurrence rate (%) of | 5.5 | 4.3 | 2.9 | 3.8 | 1.4 | 0.9 | 2.2 | 1.9 | 0.0 |
| | | noise of 70 dB or more | | | | | | | | | |
| Determi- | Strength | Shear strength (N/cm²) | A | A | A | A | A | B | A | B | B |
| nation | | at normal temperature | | | | | | | | | |
| | Friction | Friction coefficient in | A | B | B | A | B | C | B | B | B |
| | performance | second effectiveness | | | | | | | | | |
| | | Lowest friction coefficient | A | B | B | B | B | B | B | B | B |
| | | in first fade | | | | | | | | | |
| | Aggressiveness | Wear amount (μm) of | B | B | A | B | A | A | A | A | A |
| | against | counterpart material | | | | | | | | | |
| | counterpart | | | | | | | | | | |
| | material | | | | | | | | | | |
| | Brake noise | Occurrence rate (%) of | C | B | B | B | B | B | B | B | A |
| | | noise of 70 dB or more | | | | | | | | | |

| | | | | Example | | | | | Comparative Example | |
|---|---|---|---|---|---|---|---|---|---|---|
| (% by mass) | | | | 10 | 11 | 12 | 13 | 14 | 1 | 2 |
| Blending | Binder | | Phenol | 7.0 | 7.0 | 7.0 | 7.0 | 7.0 | 7.0 | 7.0 |
| compo- | | | resin | | | | | | | |
| sition | Friction | Inorganic | Calcium | 5.0 | 5.0 | 5.0 | 5.0 | 5.0 | 5.0 | 5.0 |
| | modifier | filler | hydroxide | | | | | | | |
| | | | Barium | 9.0 | 8.0 | 6.0 | 3.0 | 1.0 | 19.0 | 9.0 |
| | | | sulfate | | | | | | | |
| | | | Potassium | — | — | — | — | — | — | 10.0 |
| | | | titanate | | | | | | | |
| | | | Zinc powder | 6.0 | 6.0 | 6.0 | 6.0 | 6.0 | 6.0 | 6.0 |
| | | Abrasive | Alumina | 3.0 | 3.0 | 3.0 | 3.0 | 3.0 | 3.0 | 3.0 |
| | | | Zirconium | 5.0 | 5.0 | 5.0 | 5.0 | 5.0 | 5.0 | 5.0 |
| | | | silicate | | | | | | | |
| | | | Magnesium | — | 3.0 | 5.0 | 8.0 | 10.0 | — | — |
| | | | oxide | | | | | | | |
| | | | Chromium | 5.0 | 5.0 | 5.0 | 5.0 | 5.0 | 5.0 | 5.0 |
| | | | oxide | | | | | | | |
| | | Lubricant | Tin sulfide | 10.0 | 10.0 | 10.0 | 10.0 | 10.0 | 10.0 | 10.0 |
| | | | Coke | 10.0 | 8.0 | 8.0 | 8.0 | 8.0 | — | — |
| | | | Natural | 3.0 | 3.0 | 3.0 | 3.0 | 3.0 | — | 3.0 |
| | | | graphite | | | | | | | |
| | | | Artificial | 2.0 | 2.0 | 2.0 | 2.0 | 2.0 | 5.0 | 2.0 |
| | | | graphite | | | | | | | |

| | | | | | | | | |
|---|---|---|---|---|---|---|---|---|
| Fiber base | Aramid fiber | 5.0 | 5.0 | 5.0 | 5.0 | 5.0 | 5.0 | 5.0 |
| material | Steel fiber | 30.0 | 30.0 | 30.0 | 30.0 | 30.0 | 30.0 | 30.0 |

| Total amount (% by mass) | | | 100.0 | 100.0 | 100.0 | 100.0 | 100.0 | 100.0 | 100.0 |
|---|---|---|---|---|---|---|---|---|---|
| Evalu- | Strength | Shear strength (N/cm²) | 545 | 575 | 580 | 570 | 550 | 480 | 650 |
| ation | | at normal temperature | | | | | | | |
| | Friction | Friction coefficient | 0.36 | 0.42 | 0.43 | 0.43 | 0.45 | 0.48 | 0.29 |
| | performance | in second effectiveness | | | | | | | |
| | | Lowest friction coefficient | 0.24 | 0.31 | 0.30 | 0.31 | 0.33 | 0.25 | 0.19 |
| | | in first fade | | | | | | | |
| | Aggressiveness | Wear amount (μm) | 11.5 | 16.6 | 17.2 | 18.5 | 23.3 | 27.5 | 17.6 |
| | against | of counterpart | | | | | | | |
| | counterpart | material | | | | | | | |
| | material | | | | | | | | |
| | Brake noise | Occurrence rate (%) of | 3.5 | 1.7 | 0.9 | 0.0 | 2.5 | 14.3 | 4.5 |
| | | noise of 70 dB or more | | | | | | | |
| Determi- | Strength | Shear strength (N/cm²) | B | B | B | B | B | C | A |
| nation | | at normal temperature | | | | | | | |
| | Friction | Friction coefficient in | B | A | A | A | A | A | D |
| | performance | second effectiveness | | | | | | | |
| | | Lowest friction coefficient | C | A | A | A | A | B | D |
| | | in first fade | | | | | | | |
| | Aggressiveness | Wear amount (μm) of | A | B | B | B | C | D | B |
| | against | counterpart material | | | | | | | |
| | counterpart | | | | | | | | |
| | material | | | | | | | | |
| | Brake noise | Occurrence rate (%) of | B | B | B | A | B | D | B |
| | | noise of 70 dB or more | | | | | | | |

As seen from the results in Table 1, the friction materials according to Examples 1 to 14 have high strength, have a sufficient friction coefficient, and can prevent the aggressiveness against the counterpart material and the brake noise.

Although the present invention has been described in detail with reference to a specific embodiment, it will be apparent to those skilled in the art that various changes and modifications can be made without departing from the spirit and the scope of the present invention. The present application is based on a Japanese Patent Application (Japanese Patent Application No. 2019-229438) filed on Dec. 19, 2019, and the content thereof is incorporated herein as reference.

1: A friction material comprising:
a friction modifier;
a binder; and
a fiber base material, wherein
a steel fiber is contained as the fiber base material,
a natural graphite is contained as a lubricant,
a content of copper is 0.5% by mass or less in terms of copper element, and
a titanate is not contained.

2: The friction material according to claim 1, wherein a content of the natural graphite is 1.0% by mass to 5.0% by mass.

3: The friction material according to claim 1, wherein a content of the steel fiber is 10% by mass to 50% by mass.

4: The friction material according to claim 1, wherein a coke is further contained as the lubricant.

5: The friction material according to claim 1, wherein a magnesium oxide is contained as an abrasive.

6: The friction material according to claim 2, wherein a content of the steel fiber is 10% by mass to 50% by mass.

7: The friction material according to claim 2, wherein a coke is further contained as the lubricant.

8: The friction material according to claim 3, wherein a coke is further contained as the lubricant.

9: The friction material according to claim 2, wherein a magnesium oxide is contained as an abrasive.

10: The friction material according to claim 3, wherein a magnesium oxide is contained as an abrasive.

11: The friction material according to claim 4, wherein a magnesium oxide is contained as an abrasive.
